(19) United States
(12) Patent Application Publication
(10) Pub. No.: US 2026/0090503 A1
(43) Pub. Date: Apr. 2, 2026

(54) Agricultural Harvester and Method of Operating the Same

(71) Applicant: CLAAS Saulgau GmbH, 88348 Bad Saulgau (DE)

(72) Inventor: Simon Stützle, Bad Saulgau (DE)

(21) Appl. No.: 19/338,486

(22) Filed: Sep. 24, 2025

(30) Foreign Application Priority Data
Sep. 27, 2024 (DE) 102024128148.0

(51) Int. Cl. A01D 67/00; A01D 57/20; A01D 84/00

(52) U.S. Cl. CPC A01D 67/00; A01D 57/20; A01D 84/00

(57) ABSTRACT

Agricultural harvester (10), having a frame or a framework (12) on which a chassis (14) and/or an attachment device for receiving on a carrier vehicle engages, having working units (17) which, in a working position of the harvester, are supported via supporting devices (20) on a ground surface, having ground relief devices (21, 24) via which, in the working position of the harvester, a contact force or a contact pressure of the working units (17) on the ground surface is settable, having sensors (22) which are configured to measure for each working unit (17) a working weight thereof or a weight of the crops situated thereon or a contact force according to this, or a contact pressure according to this, of the respective working unit (17) on the ground surface, and having a control unit (23) which is configured to control the ground relief devices (21, 24) according to the measurement variables of the sensors (22) in order to influence the contact forces or contact pressures of the working units (17). FIG. 1

The invention relates to an agricultural harvester. The invention also relates to a method for operating an agricultural harvester.

Agricultural harvesters that can be coupled to a towing vehicle in order to be moved by being pulled with the aid of the towing vehicle, that is to say pulled by the towing vehicle, are known in practice. Such agricultural harvesters, moved by being pulled by a towing vehicle, are in particular forage harvesters, such as for example windrowers or tedders. It is also known to attach agricultural harvesters to the front of a towing vehicle or tractor and to move them by pushing them. Such agricultural harvesters are for example mowers or front belt rakes.

DE 10 2019 118 738 A1 discloses an agricultural harvester designed as a merger and having a frame or framework, having a chassis which engages on the frame or framework, having booms which engage on the frame or framework, and having working units. The working units each have a receiving device, specifically a pickup, and a transverse conveyor device, specifically a transverse conveyor segment. In the working position of the harvester, the working units are supported via feeler wheels on the ground surface to be worked on.

DE 10 2020 106 804 A1 discloses a further agricultural harvester designed as a merger. The harvester can advantageously be transferred between a transport position and a headland position with the aid of an actuator.

In the case of the agricultural harvesters known from the prior art, the working units are supported on the ground surface to be worked on via supporting devices designed as feeler wheels. In this case, the working units exert a contact force or a contact pressure on the ground surface to be worked on. For allowing the ground surface to be worked on as gently as possible, ground relief is important.

It is an object of the invention to provide an agricultural harvester with improved ground relief and a method for operating said agricultural harvester.

Said object is achieved by an agricultural harvester according to Claim 1 and by a method according to Claim 11.

The agricultural harvester according to the invention has a frame or a framework on which a chassis and/or an attachment device for receiving on a carrier vehicle engages.

The agricultural harvester according to the invention furthermore has working units which, in the working position of the harvester, are supported via supporting devices on a ground surface to be worked on.

The agricultural harvester according to the invention furthermore has ground relief devices via which, in the working position of the harvester, a contact force or a contact pressure of the working units on the ground surface to be worked on is settable.

The agricultural harvester according to the invention furthermore has sensors which are configured to measure for each working unit a working weight thereof or a weight of the crops situated thereon or a contact force according to this, or a contact pressure according to this, of the respective working unit on the ground surface to be worked on.

The agricultural harvester according to the invention furthermore has a control unit which is configured to control the ground relief devices according to the measurement variables of the sensors in order to influence the contact forces or contact pressures of the working units.

In the case of the harvester according to the invention, particularly advantageous ground relief is possible. With the aid of the sensors, it is possible to determine for each working unit individually the working weight thereof or the weight of the crops situated thereon or the contact pressure according to this, or the contact force according to this, of the respective working unit on the ground surface to be worked on, in order to control the ground relief devices according to the measurement variables of the sensors. In this way, the contact forces or the contact pressures of the working units on the ground surface to be worked on can be advantageously adapted for the advantageous ground relief.

Preferably, the control unit is configured to control ground relief devices according to the measurement variables of the sensors in such a way that the contact forces or contact pressures of the working units approximate to a predefined value.

The agricultural harvester according to the invention preferably furthermore has booms, wherein, on both sides of the frame or framework, in each case at least one boom engages on the frame or framework in such a way that, in order to transfer the harvester between a working position and a transport position, the respective boom is displaceable relative to the frame or framework.

Preferably, each working unit is pivotable about a pivot axis relative to the respective boom, wherein each working unit is assigned at least two sensors, specifically for example at least a sensor on a first side of the pivot axis and a second sensor on a second side of the pivot axis of the respective working unit, wherein the control unit is configured to determine for each working unit, according to the measurement variables of the sensors of the respective working unit, a differential moment acting in relation to the pivot axis of the respective working unit, and wherein the control unit is configured to control the ground relief device of the respective working unit according to the differential moment in such a way that the respective differential moment is reduced and/or set to a predetermined value. In this way, it possible to ensure that, over the width of the respective working unit, for the latter, there is a uniform contact pressure or a uniform contact force on the ground surface to be worked on.

In this context, it would also be conceivable to have a sensor that measures the total weight and a further sensor that measures the distribution or load on one side.

Preferably, the agricultural harvester is a forage harvester, in particular a merger or a pickup belt rake, wherein a pickup and a transverse conveyor segment engage, as a working unit, on each of the booms. The invention is preferably used in a merger.

Preferred refinements of the invention emerge from the dependent claims and the description below. Exemplary embodiments of the invention will be discussed in more detail on the basis of the drawing, without being limited thereto. In the drawing:

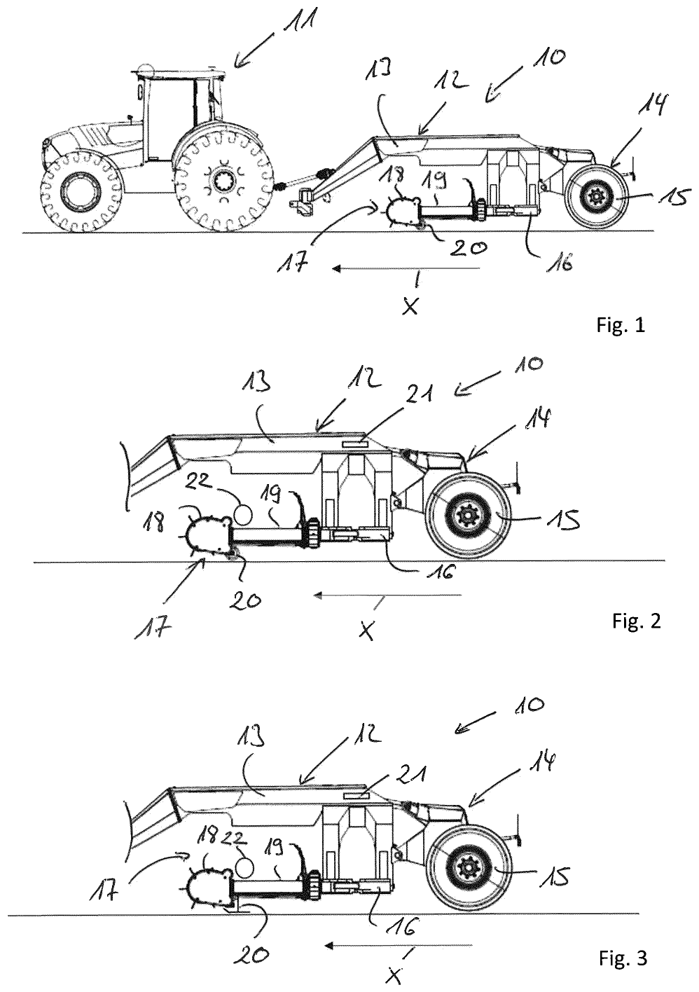

FIG. 1 shows an agricultural harvester together with a towing vehicle in a side view;

FIG. 2 shows a detail from FIG. 1;

FIG. 3 shows an alternative to the detail from FIG. 1;

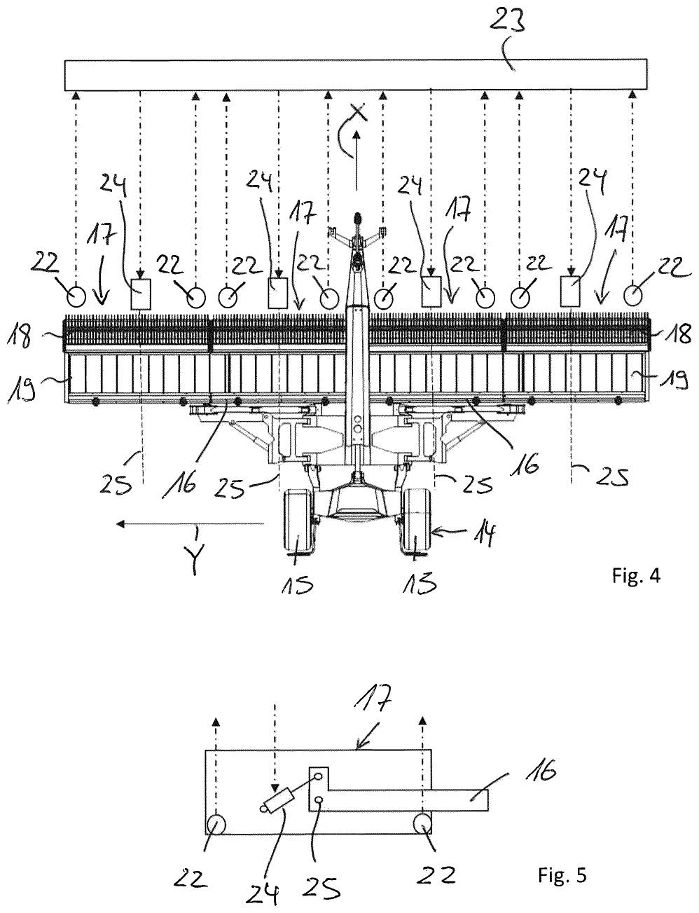

FIG. 4 shows a plan view of the agricultural harvester according to the invention;

FIG. 5 shows a detail from FIG. 4.

The invention relates to an agricultural harvester 10.

The agricultural harvester 10 is in particular a forage harvester that can be coupled to the towing vehicle 11 in order to be pulled by a towing vehicle.

FIG. 1 shows a side view of a towing combination made up of an agricultural harvester 10 and a towing vehicle 11. The agricultural harvester 10 is preferably a forage harvester, in particular a merger, which is also referred to as a pickup belt rake.

The agricultural harvester 10 has a framework or frame 12, wherein the framework or frame 12 has a longitudinal member 13 which extends in the longitudinal direction X of the agricultural harvester 10.

A chassis 14 with wheels 15 and also an attachment device for receiving on or coupling to a carrier vehicle or towing vehicle engages on the frame or framework 12 of the agricultural harvester 10. When the agricultural harvester 10 is being pulled along with the aid of the towing vehicle 11, the wheels 15 of the chassis 14 are supported on the ground surface to be worked on.

Alternatively, the agricultural harvester 10 could be designed without its own chassis and be received on a carrier vehicle by way of an attachment device. Furthermore, it is also possible for the harvester 10 to be designed as a self-propelled harvester.

The agricultural harvester 10 furthermore has booms 16.

On both sides of the frame or framework 12, specifically on both sides of the longitudinal member 13, in each case one boom 16 engages on the frame or framework 12, specifically in such a way that, in order to transfer the harvester 10 between a working position and a transport position, the respective boom 16 is displaceable relative to the frame or framework 12.

FIGS. 1 to 4 in each case show the agricultural harvester 10 in its working position.

The agricultural harvester 10 furthermore has working units 17.

In each case at least one working unit 17 engages on each boom 16 and is displaceable together with the respective boom 16, specifically during the transfer of the harvester 10 between the working position and the transport position. In the exemplary embodiment shown, in which the agricultural harvester 10 is designed as a merger, each working unit 17 has a pickup 18 and a transverse conveyor segment 19, wherein the transverse conveyor segments 19 of the working units 17 form a belt conveyor or transverse conveyor extending in the transverse direction Y of the agricultural harvester 10.

In the working position of the agricultural harvester 10, the working units 17 are supported via supporting devices 20 on the ground surface to be worked on, wherein feeler rollers are shown in FIGS. 1 and 2, and skids are shown in FIG. 3, as supporting devices 20.

The agricultural harvester 10 according to the invention has ground relief devices 21. A contact force or a contact pressure of the working units 17 on the ground surface to be worked on can be set in the working position of the harvester 10 via the ground relief devices 21.

The ground relief devices 21 shown in FIGS. 2 and 3 act in this case on the respective boom 16 in order, via the respective boom 16, to either lift the respective working unit 17 from the ground to a greater extent or move it towards the ground to a greater extent and thus, ultimately, to set the contact pressure or the contact force of the respective working unit 17 engaging with the respective boom 16.

Alternatively, the ground relief devices 21 may also act directly on the working units 17.

The agricultural harvester 10 according to the invention furthermore has sensors 22. The sensors 22 are configured to measure for each working unit 17 a working weight thereof or a weight of the crops situated thereon or a contact force according to this, or a contact pressure according to this, of the respective working unit 17 on the ground surface to be worked on.

The working weight of a working unit 17 is to be understood as meaning the weight thereof as such and the weight of the crops situated thereon.

The sensors 22 may be assigned to the supporting devices 20 of the working units 17, wherein then, with the aid of the sensors 22, in particular the working weight of the working units 17 can be detected. It is also possible that the sensors 22 are assigned to the transverse conveyor segments 19 of the working units 17 in order then to measure in particular the weight of the crops situated on the transverse conveyor segments 19 of the working units 17.

The sensors 22 may in this case be designed for example as strain gauges, pressure sensors or measurement bolts. A sensor, assigned to a transverse conveyor segment 19, may also be a camera to determine the weight of crops situated on the transverse conveyor segment 19 of the agricultural harvester according to the image captured by the camera.

The agricultural harvester 10 furthermore has a control unit 23 (not shown in FIGS. 1 to 3 but shown, highly schematically, in FIG. 4).

The control unit 23 is configured to control the ground relief devices 21 according to the measurement variables of the sensors 22 in order to influence the contact forces or contact pressures of the working units 17 on the ground surface to be worked on.

The control unit 23 can thus be configured to control the ground relief devices 21 according to the measurement variables of the sensors 22 in such a way that the contact forces or contact pressures of the working units 17 approximate to a predefined value.

Furthermore, the control unit 23 can be configured to control ground relief devices 24 (see FIG. 4) of the working units 17 according to the measurement variables of the sensors 22 in such a way that the contact forces or contact pressures of all the working units 17 approximate to one another.

Thus, whereas in FIGS. 2 and 3 the ground relief device 21 shown acts uniformly on the respective boom 16 and thus on all the working units 17 engaging on the respective boom 16, in FIG. 4 each working unit 17 is assigned an individual ground relief device 24 which can individually influence the contact force or contact pressure for the respective working unit 17.

Preferably, each working unit 17 is individually pivotable about a pivot axis 25 relative to the respective boom 16. In this case, in FIG. 4, each working unit 17 is assigned two sensors 22, specifically at least a sensor 22 on a first side of the pivot axis 25 and a second sensor 22 on a second side of the pivot axis 25 of the respective working unit 17. These sensors 22 communicate their measurement variables to the control unit 23, which is configured to determine for each working unit 17, according to the measurement variables of the sensors 22 of the respective working unit 17, a differential moment acting in relation to the pivot axis 25 of the respective working unit 17.

The control unit 23 is then further configured to control the ground relief device 24 of the respective working unit 17 according to the determined differential moment in such a way that the respective differential moment is reduced, in particular in such a way that a magnitude thereof is smaller than a predefined limit value or is preferably zero.

In FIG. 4, it can be ensured not only that the contact forces or contact pressures of all the working units 17 approximate to one another, but also that there is a uniform contact force or uniform contact pressure of the respective working unit 17 on the ground surface over the width of the respective working unit 17.

FIG. 5 shows a detail from the agricultural harvester 10 in FIG. 4 in the region of a working unit 17, wherein FIG. 5 shows the pivot axis 25 about which the respective working unit 17 is pivotable relative to the boom 16, as well as the ground relief device 24, which, on the one hand, engages in an articulated manner on the working unit 17 and, on the other hand, engages on the boom 16 in order to apply a moment to the respective working unit 17, specifically in such a way that the differential moment at the respective working unit 17 is preferably zero.

The control unit 23 can act on the ground relief devices 21, 24 either via a controller or a regulator. If the control unit 23 acts on the ground relief devices 21, 24 in the sense of regulation, measurement values of the sensors 22 are continuously evaluated and, according to this, the ground relief devices 21, 24 are continuously readjusted in the sense of regulation in order to ensure for example that an actual contact force or an actual contact pressure at a respective working unit 17 corresponds to a predefined target contact pressure or a predefined target contact force.

With the invention, it is therefore proposed to use sensors 22 to measure the working weight of working units 17 or the weight of the crops situated on the working units 17 or the contact force or contact pressure of the respective working unit 17 on the ground surface to be worked on and to control, according to this, ground relief devices 21, 24.

With the invention, it is possible to provide a ground relief function which allows the ground surface to be worked on in a particularly gentle manner, specifically uniformly over the entire working width of the harvester 10 and over the respective width of the respective working unit 17. This is particularly advantageous in particular in the case of a merger, or pickup belt rake, in which the working weight of the working units 17 increases steadily or continuously in the conveying direction of the transverse conveyor device formed by the transverse conveyor segments 19.

The invention furthermore relates to a method for operating an agricultural harvester 10, wherein the working weight of working units 17 or the weight of crops situated on the working units 17 or, according to this, a contact force or a contact pressure of the respective working unit 17 on the ground surface to be worked on is measured in order to control, according to the measurement variables, the ground relief devices 21, 24 in such a way that contact forces and contact pressures of the working units 17 are influenced.

### LIST OF REFERENCE SIGNS

10 Harvester
11 Towing vehicle
12 Framework/frame
13 Longitudinal member
14 Chassis
15 Wheel
16 Boom
17 Working unit
18 Pickup
19 Transverse conveyor segment
20 Supporting device
21 Ground relief device
22 Sensor
23 Control unit
24 Ground relief device
25 Pivot axis

1. An agricultural harvester (10) having:
a frame or a framework (12) on which a chassis (14) and/or an attachment device for receiving on a carrier vehicle engages,
working units (17) which, in a working position of the harvester, are supported via supporting devices (20) on a ground surface to be worked on,
ground relief devices (21, 24) via which, in the working position of the harvester, a contact force or a contact pressure of the working units (17) on the ground surface to be worked on is settable,
sensors (22) which are configured to measure for each working unit (17) a working weight thereof or a weight of the crops situated thereon or a contact force according to this, or a contact pressure according to this, of the respective working unit (17) on the ground surface to be worked on,
a control unit (23) which is configured to control the ground relief devices (21, 24) according to the measurement variables of the sensors (22) in order to influence the contact forces or contact pressures of the working units (17).

2. The agricultural harvester (10) according to claim 1, characterized in that the sensors (22) are assigned to the supporting devices (20) of the working units (17).

3. The agricultural harvester (10) according to claim 1, characterized in that the sensors (22) are assigned to transverse conveyor segments (19) of the working units (17).

4. The agricultural harvester (10) according to claim 1, characterized in that the control unit (23) is configured to control ground relief devices (21) according to the measurement variables of the sensors (22) in such a way that the contact forces or contact pressures of the working units (17) approximate to a predefined value.

5. The agricultural harvester (10) according to claim 1, characterized in that
each working unit (17) is pivotable about a pivot axis (25) relative to a respective boom (16),
each working unit (17) is assigned at least two sensors (22), specifically at least a sensor (22) on a first side of the pivot axis (25) of the respective working unit (17) and a second sensor (22) on a second side of the pivot axis (25) of the respective working unit (17),
the control unit (23) is configured to determine for each working unit (17), according to the measurement variables of the sensors (22) of the respective working unit (17), a differential moment acting in relation to the pivot axis (25) of the respective working unit (17),
the control unit (23) is configured to control the ground relief device (24) of the respective working unit (17) according to the differential moment in such a way that the respective differential moment is reduced.

6. The agricultural harvester (10) according to claim 5, characterized in that the control unit (23) is configured to control the ground relief device (24) of the respective working unit (17) according to the differential moment in such a way that the respective differential moment is reduced to a magnitude which is smaller than a predefined limit value.

7. The agricultural harvester (10) according to claim 5, characterized in that the control unit (23) is configured to control the ground relief device (24) of the respective working unit (17) according to the differential moment in such a way that the respective differential moment is reduced to zero.

8. The agricultural harvester (10) according to claim 1, characterized in that said agricultural harvester is a forage harvester.

9. The agricultural harvester (10) according to claim 8, characterized in that the forage harvester is a merger or a pickup belt rake.

10. A method for operating an agricultural harvester (10) according to claim 1, comprising the following steps:
for each working unit (17), measuring the working weight thereof or the weight of the crops situated thereon or the contact force according to this, or the contact pressure according to this, of the respective working unit (17) on the ground surface to be worked on,
controlling the ground relief devices (21, 24) according to the measurement variables in order to influence the contact forces or contact pressures of the working units (17).
